(19) United States
(12) Patent Application Publication
(10) Pub. No.: US 2022/0342370 A1
(43) Pub. Date: Oct. 27, 2022

(54) ELECTRONIC WATCH

(71) Applicant: CITIZEN WATCH CO., LTD., Tokyo (JP)

(72) Inventors: Satoshi IKEYAMA, Nishitokyo-shi, Tokyo (JP); Gisuke TOKUYAMA, Tokyo (JP)

(73) Assignee: CITIZEN WATCH CO., LTD., Tokyo (JP)

(21) Appl. No.: 17/762,143

(22) PCT Filed: Jul. 22, 2020
(86) PCT No.: PCT/JP2020/028418

§ 371 Date: Mar. 21, 2022

(30) Foreign Application Priority Data
Sep. 25, 2019 (JP) 2019-173660

(51) Int. Cl. G04B 19/04; G04B 19/06

(52) U.S. Cl. CPC G04B 19/04; G04B 19/06

(57) ABSTRACT

An electronic watch includes: a time display unit 3 configured to perform time display based on an internal time; a time setting unit (movement 5) configured to set the internal time based on a reference time and a time zone; an operation unit 5 configured to perform at least a selecting operation of selecting one time zone TZ from among a plurality of time zones TZ; and a display unit (facing ring 33) configured to perform time zone display TD corresponding to each of the time zones TZ. The selecting operation is to indicate a time zone display TD to be selected from among a plurality of the time zone displays TD. The time zone displays TD include one or more first displays TD1 based on a city name included in the time zone TZ, a region, or a time difference, and one or more second displays TD2 based on a landmark included in the time zone TZ. A user who uses the electronic watch can correctly select the time zone depending on a purpose of changing the time zone of the user.

### FIELD

The present invention relates to an electronic watch.

### BACKGROUND

Typically, some electronic watches change a time zone by being operated by a user, and perform time display corresponding to the changed time zone. In a case of changing the time zone by the user, the time zone is changed by rotating a hand in a time zone changing mode by an operation unit to indicate a time zone display corresponding to each time zone. Each time zone display is mainly a city name, an abbreviated city name obtained by abbreviating a city name, a number representing a time difference from a reference time, or the like (refer to Patent Literature 1).

### CITATION LIST

### Patent Literature

Patent Literature 1: Japanese Patent Application Laid-open No. 2018-159679

### SUMMARY

### Technical Problem

In a case in which each time zone display described above is a city name or an abbreviated city name, for example, the time zone display is related to a capital of a major country included in the time zone. Thus, in a case in which a user is present in another country included in the same time zone as that of the major country, the user is required to recognize that the same time zone includes the major country and the other country, and it is difficult to change the time zone based on the time zone display. Specifically, in a case in which the user moves between time zones for the purpose of sports or activity, the user directly goes to a destination without making a stopover in the capital and the like in many cases. In this case, the user does not recognize the capital even if the user is present in the major country, so that it is difficult to change the time zone based on the time zone display.

The present invention has been made in view of such a situation, and provides an electronic watch with which a user who uses the electronic watch can correctly select a time zone depending on a purpose of changing the time zone of the user.

### Solution to Problem

In order to solve the above mentioned problem and achieve the object, an electronic watch according to the present embodiment includes a time display unit configured to perform time display based on an internal time; a control circuit including a time setting unit configured to set the internal time based on a reference time and a time zone; a display unit configured to perform time zone display corresponding to each of a plurality of time zones; and an operation unit configured to perform selecting operation of selecting one time zone from among the time zones on the display unit, wherein the time zone display includes: one or more first displays based on a city name included in a time zone, a region, or a time difference, and one or more second displays based on a landmark included in the time zone.

### Advantageous Effects of Invention

With a watch according to the present invention, a user who uses an electronic watch can correctly select a time zone depending on a purpose of changing the time zone of the user.

### BRIEF DESCRIPTION OF DRAWINGS

FIG. 1 is an entire configuration diagram of an electronic watch according to an embodiment.

FIG. 2 is an enlarged view of a principal part (a time zone selected state) of the electronic watch according to the embodiment.

FIG. 3 is an enlarged view of a principal part (a time zone selected state) of the electronic watch according to the embodiment.

FIG. 4 is a diagram related to time zone displays.

FIG. 5 is a diagram related to an example of time zones.

FIG. 6 is a block diagram of a movement of the electronic watch according to the embodiment.

FIG. 7 is an entire configuration diagram of an electronic watch according to a modification.

FIG. 8 is a diagram related to time zone displays according to the modification.

FIG. 9 is an entire configuration diagram of the electronic watch according to the modification.

FIG. 10 is a diagram related to time zone displays according to the modification.

FIG. 11 is an entire configuration diagram of the electronic watch according to the modification.

FIG. 12 is an entire configuration diagram of the electronic watch according to the modification.

### DESCRIPTION OF EMBODIMENTS

The following describes the present invention in detail with reference to the drawings. The present invention is not limited to the following embodiment. Constituent elements in the following embodiment encompass a constituent element that is easily conceivable by those skilled in the art, or substantially the same constituent element.

### Embodiment

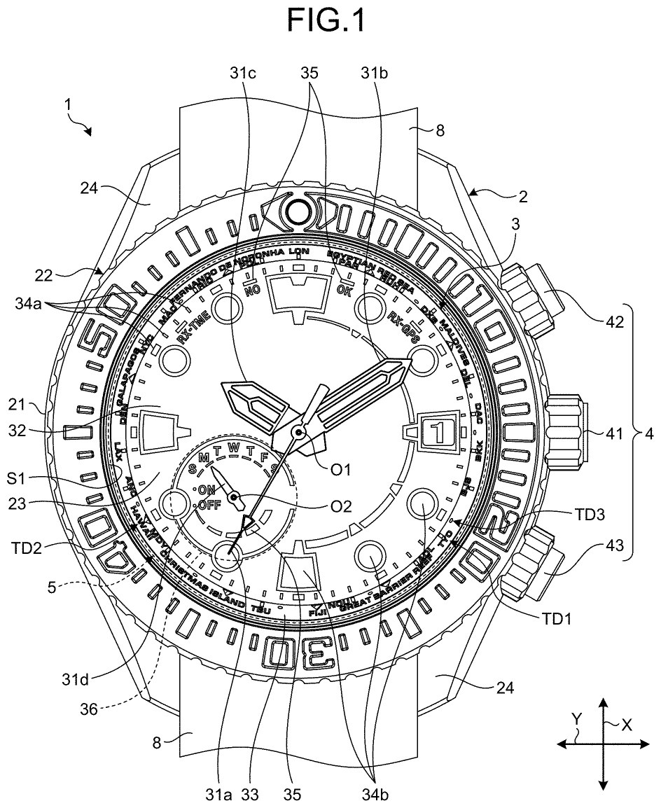

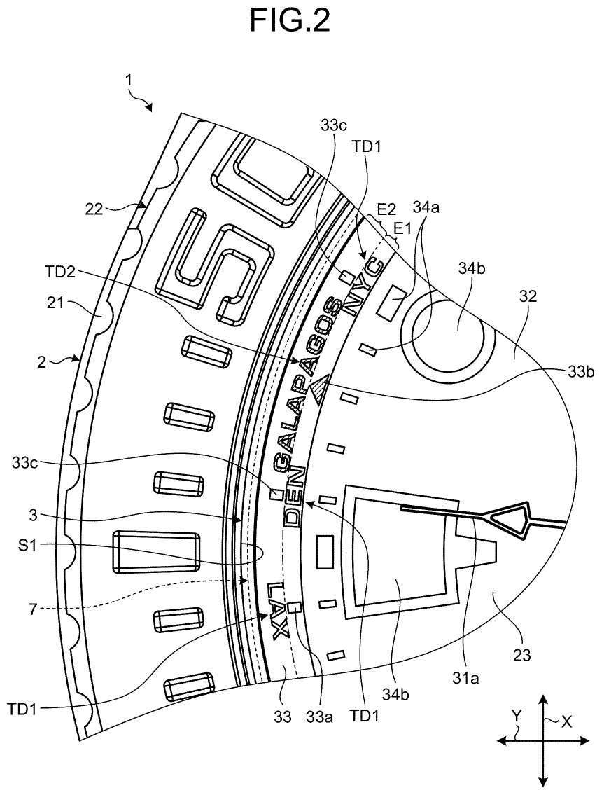

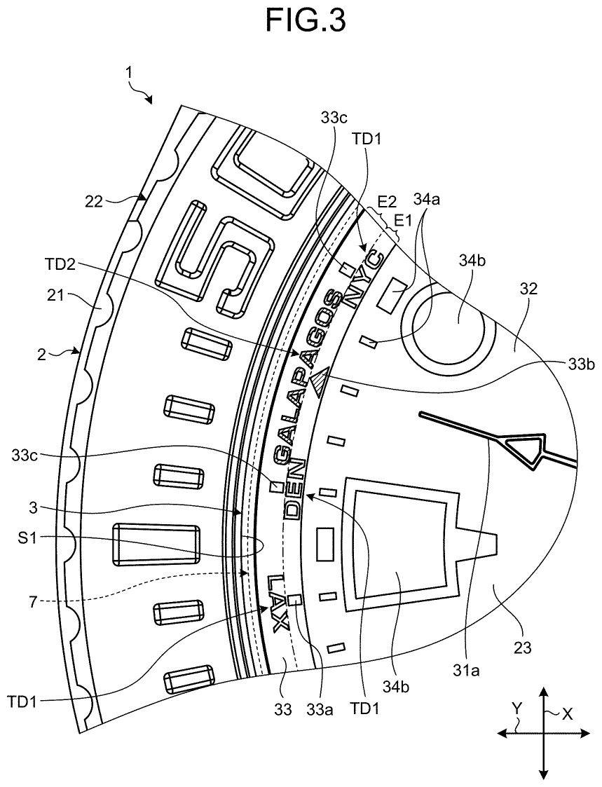

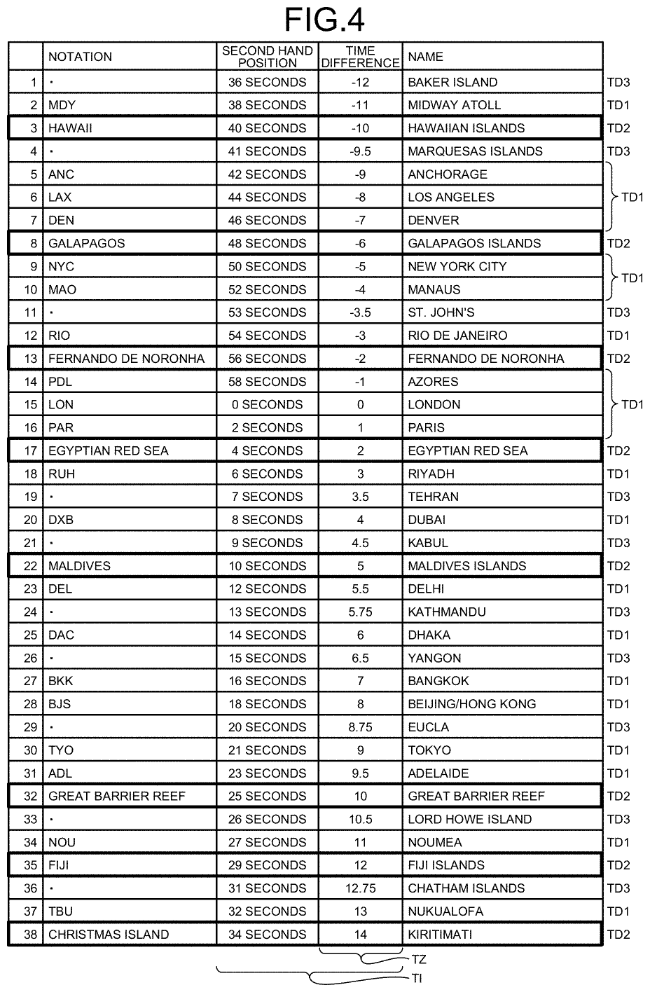

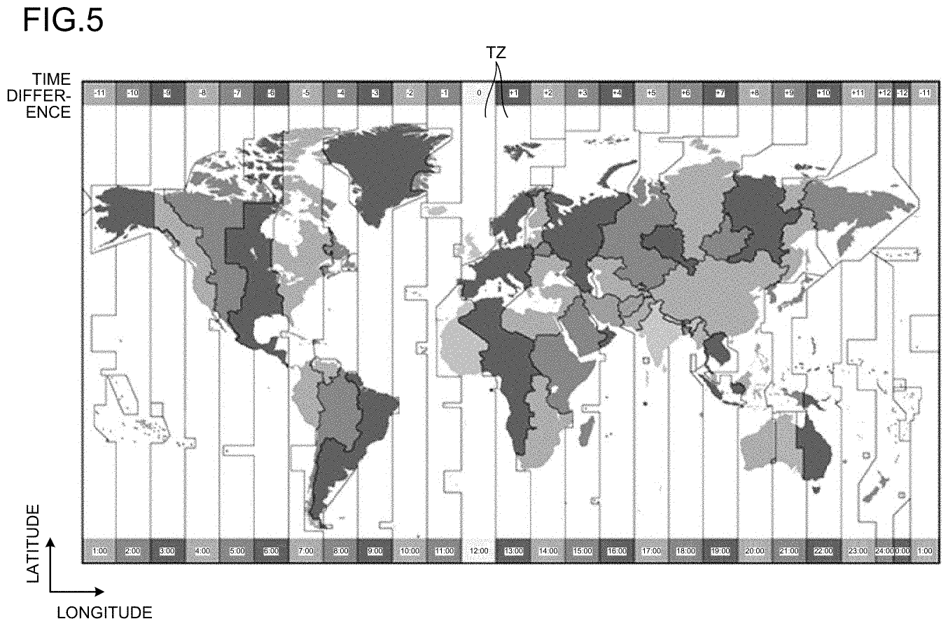

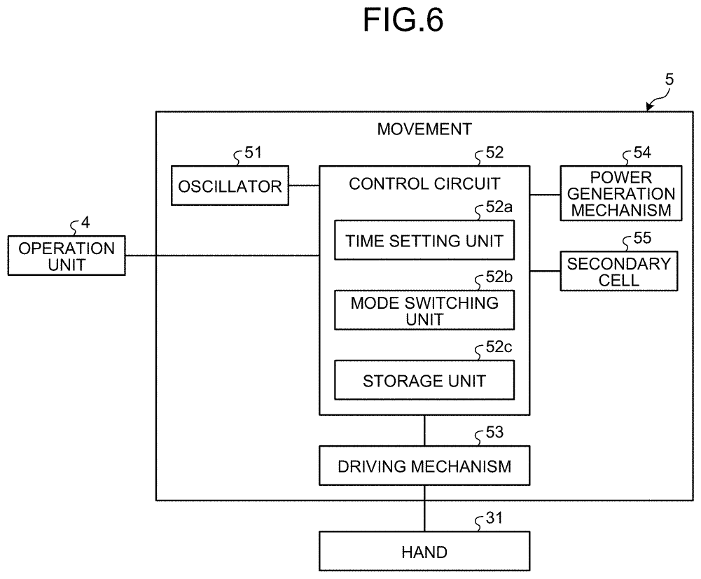

FIG. 1 is an entire configuration diagram of an electronic watch according to an embodiment. FIG. 2 is an enlarged view of a principal part (a time zone selected state) of the electronic watch according to the embodiment. FIG. 3 is an enlarged view of the principal part (the time zone selected state) of the electronic watch according to the embodiment. FIG. 4 is a diagram related to time zone displays. FIG. 5 is a diagram related to time zones. FIG. 6 is a block diagram of a movement of the electronic watch according to the embodiment. FIG. 2 and FIG. 3 are enlarged views of a vicinity of 9 o'clock of an electronic watch 1 illustrated in FIG. 1. The X-direction in FIG. 1 to FIG. 3 is a direction along 12 o'clock and 6 o'clock of the electronic watch, the Y-direction is a direction along 3 o'clock and 9 o'clock of the electronic watch, and a direction orthogonal to the X-direction and the Y-direction is an upper and lower direction of the electronic watch. O1 is the center of the electronic watch 1, and agrees with a rotation axis of a hand. A direction centered on O1 on the XY-plane is referred to as a radial direction.

The electronic watch 1 according to the embodiment is an electronic watch clocking an internal time based on an output from a quartz oscillator, and indicating the clocked time by hands 31. The electronic watch 1 may also be a multi-functional electronic watch having an alarm function or a function of a chronograph and the like in addition to a clocking function. The electronic watch 1 may also be a radio-controlled watch that receives standard radio waves or radio waves of a global positioning system (GPS) output from a satellite, and corrects the internal time based on time information of the received radio waves. Furthermore, the electronic watch 1 may be a watch interlocking with a terminal appliance that is connected to an external terminal appliance via a communication unit in at least one of a wireless manner or a wired manner, and implements a specific function (for example, an alarm function, a time correction function based on internal time information of a terminal appliance, a report function of reporting reception of an e-mail, and the like) based on an instruction set in the terminal appliance.

As illustrated in FIG. 1 to FIG. 3, the electronic watch 1 includes an exterior case 2, a time display unit 3, an operation unit 4, and a movement 5. The electronic watch 1 according to the present embodiment is an analog electronic wristwatch including the time display unit 3 of an analog display type, and is a diver's watch including a diving mode for diving use. The electronic watch 1 is assumed to be a wristwatch type in the following description, but may be another watch type, for example, a pocket watch type so long as the electronic watch 1 has a function as a diver's watch.

The exterior case 2 constitutes an outermost part of the electronic watch 1, and is constituted of a case body 21, a bezel 22, a wind shield 23, and a case back (not illustrated). The case body 21 has an opening, and the time display unit 3 and the movement 5 are held in an internal space part S1 as a space inside the opening. In the present embodiment, the case body 21 has an annular shape, and the opening has a circular shape centered on the center O1 of the electronic watch 1. The shape of the opening may be an optional shape corresponding to an external shape or design of the exterior case 2 of the electronic watch 1. The case body 21 includes bows 24 formed to respectively project from the 12 o'clock direction and the 6 o'clock direction of an outer peripheral side surface. One end of a belt 8 is coupled to the bow 24 on the 12 o'clock side, and the other end of the belt 8 is coupled to the bow 24 on the 6 o'clock side.

The wind shield 23 covers an upward opening as one side of the opening of the case body 21, the case back covers a downward opening as the other side thereof, and the wind shield 23 and the case back are fixed. Accordingly, the internal space part S1 becomes a blocked space, so that the time display unit 3 and the movement 5 can be protected. By fixing the wind shield 23 and the case back to the case body 21 via a waterproof member (not illustrated) such as a rubber gasket, it is possible to increase holding force, thereby improving a dustproof property and a waterproof property of the electronic watch 1. For example, the case body 21 is made of a resin material, a metallic material, a ceramic material, and the like. The bezel 22 is used for fixing the wind shield 23 to the case body 21, and is formed in a ring shape. The bezel 22 is positioned on an outer circumference of the time display unit 3. The bezel 22 according to the present embodiment is supported by the case body 21 to be rotatable about the center O1 of the electronic watch 1. For example, the bezel 22 is made of a resin material, a metallic material, a ceramic material, and the like. The wind shield 23 has a shape of covering the upward opening via the bezel 22, and blocks the internal space part S1 by being inserted from an upward side to be fixed to the bezel 22, and being fixed to the case body 21 via the bezel 22. In the present embodiment, the external shape of the wind shield 23 in a plan view is a circular shape. The wind shield 23 is, for example, made of glass, a transmissive resin material, or the like. The case back includes an engagement part having substantially the same shape as the downward opening, and blocks the internal space part S1 by being inserted from a downward side to be fixed to the case body 21. In the present embodiment, the external shape of the case back is a circular shape. The case back is, for example, made of a resin material, a metallic material, a ceramic material, or the like similarly to the case body 21. The bezel 22 may be formed integrally with the case body 21 if the bezel 22 is not required to rotate.

The time display unit 3 performs time display based on an internal time. The time display unit 3 includes the hands 31, a dial plate 32, and a facing ring 33. The time display unit 3 according to the present embodiment displays the internal time clocked by a control circuit 52 (described later) of the movement 5, or performs function display related to a function different from a time display function. The time display unit 3 according to the present embodiment includes a sub-display unit 36 that can display a day of the week as the internal time, or display a function different from the time display function such as a function of displaying a battery residual quantity. For example, the sub-display unit 36 is disposed at the seven thirty position based on the center O1 of the electronic watch 1, but the embodiment is not limited thereto. The sub-display unit 36 may be disposed at the 6 o'clock position or the 9 o'clock position, or a plurality of the sub-display units may be disposed.

Each of the hands 31 is disposed to be rotatable about the center O1 of the electronic watch 1 as a rotation axis, coupled to wheelwork of the movement 5, and rotated and driven via a motor that is driven in accordance with a drive signal of a drive circuit. The hand 31 has a stick shape, and is made of a metallic material, a resin material, or the like. In the present embodiment, the hands 31 include a second hand 31a, a minute hand 31b, and an hour hand 31c, which are disposed on the upward side (to be closer to the wind shield 23 side) as compared with the dial plate 32. The hands 31 may also include an auxiliary hand 31d that is disposed to be rotatable about a center O2 of the electronic watch 1 as a rotation axis, and capable of instructing to display a function on the sub-display unit 36. The hand 31 is rotated by an operation performed by the user. The hand 31 can perform time display based on an internal time depending on an indicated position, or perform information display such as setting information corresponding to a function different from the time display function. Examples of the information display include ON/OFF setting of an alarm function, a set time of an alarm, a chronograph display, and a battery residual quantity. The hand 31 according to the present embodiment indicates a time zone display TD corresponding to a position on the facing ring 33 as a display unit (described later) indicated by the second hand 31a.

The dial plate 32 is disposed between the hand 31 and the movement 5, and protects the movement 5. The dial plate 32 has a function of giving good external appearance of the electronic watch 1 for the user. Time characters 34 (time characters 34a and 34b) are disposed on a surface of the dial plate 32 (on a side opposed to the wind shield 23). That is, the time characters 34 are disposed to be opposed to the wind shield 23 in the upper and lower direction, and can be visually recognized by the user via the wind shield 23. The user can recognize a current time based on a time display due to relative positions of the hands 31 (the second hand 31a, the minute hand 31b, and the hour hand 31c) and the time characters 34. Functional marks 35 different from the time characters 34 are disposed on the dial plate 32. The user can recognize setting information and the like of each function based on information display due to relative positions of the hands 31 (the second hand 31a, the minute hand 31b, the hour hand 31c, and the auxiliary hand 31d) and the functional marks 35.

The facing ring 33 is a display unit that performs the time zone display TD corresponding to each of time zones TZ in the present embodiment. As illustrated in FIG. 2 and FIG. 3, the facing ring 33 is disposed on a radially outer side of the dial plate 32. The facing ring 33 according to the present embodiment is formed in a ring shape, and disposed on a radially outer side as compared with a distal end of the hand 31. A plurality of the time zone displays TD are disposed on the facing ring 33. The facing ring 33 is partitioned into an inside region E1 and an outside region E2 as regions in which the time zone displays TD are disposed.

As illustrated in FIG. 4, the time zone displays TD include one or more first displays TD1, one or more second displays TD2, and one or more third displays TD3. Each of the first displays TD1 is a display based on a city name, a region, or a time difference, and is a city name or a regional name that are abbreviated, that is, an abbreviated city name or an abbreviated regional name in the present embodiment. Each of the second displays TD2 is a display based on a landmark included in the time zone TZ, and is a name of a diving spot in the present embodiment that is not abbreviated. A display mode of the second display TD2 is different from that of the first display TD1. Specifically, the color of the second display TD2 is different from that of the first display TD1. For example, when the first display TD1 is “white”, the second display TD2 is “yellow” that is watched more carefully as compared with the first display TD1. If the second display TD2 is watched more carefully as compared with the first display TD1, recognition performance of the user can be improved, so that at least one of the color, the font, and the size of the second display TD2 is preferably different from those of the first display TD1. In the present embodiment, the third displays TD3 are simple symbols (for example, elliptical dots) corresponding to a city name or a regional name, and have the same shape. The first display TD1, the second display TD1, and the third display TD3 in the present embodiment respectively correspond to different time zones TZ, and do not correspond to the same time zone TZ. As illustrated in FIG. 5, the time zones TZ are obtained by partitioning a world map into a plurality of geographical areas. For example, in a case of using Coordinated Universal Time (UTC) and assuming one of the geographical areas as a reference area, the time zone TZ is used for determining a time difference between the reference area and a geographical area different from the reference area. The time zone TZ is one geographical area in a case of assuming that a vertical direction represents latitude, and a horizontal direction represents longitude. Regarding the time zones TZ, a geographical area adjacent to the reference area (0) has a time difference of ±1 hour with respect to the reference area, and the time difference is increased as a distance from the reference area is increased.

As illustrated in FIG. 1 to FIG. 3, on the facing ring 33, at least the first displays TD1 and the second displays TD2 are displayed in order of time difference. On the facing ring 33 according to the present embodiment, the first displays TD1, the second displays TD2, and the third displays TD3 are distributed to the inside region E1 and the outside region E2, and all of the first displays TD1, the second displays TD2, and the third displays TD3 are disposed along a circumferential direction in order of time difference irrespective of the inside region E1 and the outside region E2. On the facing ring 33, “LON” as the first display TD1 representing an abbreviated city name of London having a time difference of 0 is disposed at a position corresponding to “12 o'clock” of the electronic watch 1, the first display TD1, the second display TD2, and the third display TD3 as the time zone displays TD corresponding to the respective time zones TZ the time differences of which are plus numbers are disposed clockwise in order of time difference, and the first display TD1, the second display TD2, and the third display TD3 as the time zone displays TD corresponding to the time zones TZ the time differences of which are minus numbers are disposed counterclockwise in order of time difference.

In the inside region E1 of the facing ring 33, the first display TD1 and the third display TD3 among the time zone displays TD are disposed. In the outside region E2 of the facing ring 33, the first display TD1 and the second display TD2 among the time zone displays TD are disposed. That is, the second display TD2 disposed on the facing ring 33 is positioned on a radially outer side as compared with at least part of the first displays TD1, that is, the first display TD1 within the inside region E1. On the facing ring 33, the outside region E2 on the radially outer side has a longer length in the circumferential direction than the inside region E1 on a radially inner side, so that the outside region E2 can display a larger number of items. Thus, by positioning the second display TD2 on the radially outer side, the name of the diving spot can be displayed without being abbreviated, and recognition performance of the user for the time zone display TD can be improved.

On the facing ring 33, auxiliary symbols 33a and 33c corresponding to the respective first displays TD1, and auxiliary symbols 33b corresponding to the respective second displays TD2 are disposed. Each of the auxiliary symbols 33a to 33c is a symbol as an indicator at the time when the second hand 31a selects the time zone TZ in a selecting operation. The auxiliary symbols 33a are disposed in the inside region E1. Some of the auxiliary symbols 33a are each positioned to be opposed to the first display TD1 in the circumferential direction corresponding to the first display TD1 disposed in the inside region E1, and some of the auxiliary symbols 33a are each positioned to be opposed to the first display TD1 in the radial direction corresponding to the first display TD1 disposed in the outside region E2. The auxiliary symbols 33b are disposed in the inside region E1, and are each positioned to be opposed to the second display TD2 in the radial direction corresponding to the second display TD2 disposed in the outside region E2. A display mode of the auxiliary symbol 33b is different from that of the auxiliary symbols 33a and 33c. Specifically, the shape and the color of the auxiliary symbol 33b are different from those of the auxiliary symbols 33a and 33c. For example, when the auxiliary symbols 33a and 33c have a “white” rectangular shape, the auxiliary symbol 33b has a “yellow” arrow shape that is watched more carefully as compared with the auxiliary symbols 33a and 33c. Recognition performance of the user can be improved if the auxiliary symbol 33b is watched more carefully as compared with the auxiliary symbols 33a and 33c, so that at least one of the color, the shape, and the size of the auxiliary symbol 33b may be different from those of the auxiliary symbols 33a and 33c. The auxiliary symbols 33c are disposed in the outside region E2, are each positioned to be opposed to the first display TD1 in the circumferential direction corresponding to the first display TD1 disposed in the inside region E1, and has the same shape as that of the auxiliary symbol 33a.

The operation unit 4 implements a functional operation based on an operation for the movement 5 by being operated by the user. The operation unit 4 according to the present embodiment performs at least a selecting operation for selecting one time zone TZ from the time zones TZ. Specifically, the second hand 31a as the hand performs the selecting operation for indicating the time zone display TD to be selected from among the time zone displays TD when the user operates the operation unit 4. The operation unit 4 includes a crown 41, a push button 42, and a push button 43. The crown 41 is formed to project from a side surface of the case body 21, can be pulled out by one or a plurality of steps in a projecting direction by being operated by the user, and can rotate about an axis. By rotating the crown 41 in a state of being pulled out by a step different from the zeroth step, which is not pulled out in the projecting direction, for example, in a state of being pulled out by two steps, the hand 31 in a time display state can be forcibly rotated, and time display can be corrected. The push buttons 42 and 43 are formed to project from the side surface of the case body 21, and can be pressed in a direction reverse to the projecting direction by being operated by the user. The push buttons 42 and 43 maintain a state of projecting in the projecting direction when external force is not applied thereto. The operation unit 4 is connected to the control circuit 52 of the movement 5, and outputs an operation state by the user to the control circuit 52 as an operation signal.

The movement 5 includes an oscillator 51, the control circuit 52, a driving mechanism 53, a power generation mechanism 54, a secondary cell 55, and the like, and performs a clocking function or other functional operations of the electronic watch 1.

The oscillator 51 is source oscillation for generating a reference frequency related to clocking of a display time or other functional operations of the electronic watch 1. For example, a crystal oscillator can be used as the oscillator 51. An oscillation characteristic of the crystal oscillator tends to vary depending on an external temperature, so that a temperature-compensated crystal oscillator (TCXO) may be used.

The control circuit 52 is a circuit that controls the electronic watch 1. The control circuit 52 clocks the internal time of the electronic watch 1, or output a control signal corresponding to each function based on a clock signal output from the oscillator 51. The control circuit 52 is constituted of a circuit including a central processing unit (CPU) and a storage unit 52c such as a random access memory (RAM) and a read only memory (ROM). The control circuit 52 outputs a control signal for causing the hand 31 to perform time display to the driving mechanism 53 based on the internal time that is being clocked. The control circuit 52 also corrects the internal time based on time information of radio waves. The storage unit 52c of the control circuit 52 stores time zone information TI (refer to FIG. 4) corresponding to the time zone TZ. As illustrated in FIG. 4, for example, the time zone information TI is table data obtained by associating a position indicated by the second hand 31a with a value of the time difference in each of the time zones TZ.

The control circuit 52 includes at least a time setting unit 52a and a mode switching unit 52b as functions. The time setting unit 52a sets the internal time based on a reference time and the time zone. In a case in which the time zone TZ is changed, the time setting unit 52a updates data in the storage unit 52c from the time zone information TI before the change to the time zone information TI corresponding to the time zone TZ after the change, and sets the internal time again based on the reference time and the time zone TZ after the change. The mode switching unit 52b shifts a mode of the electronic watch 1 to various modes based on an operation on the operation unit 4 performed by the user. The mode switching unit 52b according to the present embodiment can switch among at least a clocking mode, a time zone changing mode, and a diving mode. The clocking mode is a mode of performing time display based on the internal time. The time zone changing mode is, in a case in which a selected time zone is different from the time zone TZ corresponding to the time zone information TI stored in the storage unit 52c, a mode of changing the time zone, that is, updating the time zone information TI based on a selecting operation. The diving mode is a mode of causing an operation of the hand 31 performing time display based on the internal time to continue, that is, preventing the operation of the hand 31 from being stopped. For example, by pressing the push button 42 for a predetermined time in a state in which the crown 41 is at the zeroth step, the clocking mode is switched, and a display hand (not illustrated) indicates that the mode is the diving mode. Switching from the diving mode to the clocking mode is performed by pressing the push button 42 for a predetermined time in a state in which the crown 41 is at the zeroth step, for example.

The driving mechanism 53 includes a drive circuit, a motor, wheelwork, and the like. A control signal from the control circuit 52 is input to the drive circuit to drive the motor in accordance with the input signal. The wheelwork and the like coupled to the motor operate in cooperation with each other. For example, in a case in which the hand is attached to one end of the wheelwork that is supported by a base plate (not illustrated) in a rotatable manner, the hand 31 can be rotated and driven. In the present embodiment, a step motor, an electret motor, or the like can be used as the motor.

The power generation mechanism 54 generates electric power by external energy, and supplies the generated electric power to an electronic component such as a secondary cell 65 and the control circuit 52. As the power generation mechanism 54, a photoelectric conversion element that converts light energy, a thermoelectric conversion element that converts thermal energy, a mechanoelectrical conversion element that generates electric power by machine motion such as vibration energy, or the like can be used.

The secondary cell 55 is a power source that can accumulate the electric power generated by the power generation mechanism 54, and supplies the electric power to the control circuit 52, the driving mechanism 53, or other electronic components. As the secondary cell 55, for example, a lithium ion battery or an all-solid battery can be used.

Next, the following describes an operation of changing the time zone TZ by the electronic watch 1. First, the user operates the operation unit 4 for performing selecting operation for the time zone TZ. In the present embodiment, the user moves the crown 41 from the zeroth step to the first step. When determining that the crown 41 is at the first step, the control circuit 52 shifts the clocking mode to a time zone switching mode. Next, the user presses the push button 42 in a state in which the crown 41 is at the first step. When determining that the crown 41 is maintained at the first step and the push button 42 is pressed, the control circuit 52 causes the second hand 31a to rotate to indicate the time zone display TD corresponding to the time zone TZ corresponding to the time zone information TI stored in the storage unit 52c. Next, by checking the current time zone TZ and rotating the crown 41, as illustrated in FIG. 2 and FIG. 3, the user performs the selecting operation of causing the second hand 31a to indicate the time zone display TD corresponding to the time zone TZ to be changed, that is, the time zone TZ to be selected. For example, in a case in which the user wants to change the time zone to a time zone including Denver without a specific purpose such as a business trip or travel, as illustrated in FIG. 2, the user causes the second hand 31a to rotate to indicate a position at which “DEN” is disposed as the first display TD1 representing an abbreviated city name of Denver. In a case in which the user wants to change the time zone to a time zone including Galapagos (Galapagos Islands) for a specific purpose of experiencing diving, as illustrated in FIG. 3, the user causes the second hand 31a to rotate to indicate a position at which “GALAPAGOS” is disposed as the second display TD2 representing Galapagos. Next, the user returns the crown 41 from the first step to the zeroth step. When determining that the crown 41 is returned to the zeroth step, the control circuit 52 compares the time zone TZ corresponding to the time zone information TI stored in the storage unit 52c, that is, the time zone information TI before the change, with the time zone TZ corresponding to the time zone display TD indicated by the second hand 31a. If the time zones TZ are different from each other, the control circuit 52 stores, in the storage unit 52c, the time zone information corresponding to the time zone TZ corresponding to the time zone display TD indicated by the second hand 31a, that is, the time zone information TI after the change. The control circuit 52 also changes the internal time based on a difference between the time zone information TI before the change and the time zone information after the change, and performs time display based on the changed internal time.

As described above, in a case of changing the time zone for a specific purpose, the second display TD2 as the time zone display TD corresponding to the specific purpose among the time zone displays TD can be identified more easily as compared with the first display TD1 and the third display TD3 as the other time zone displays TD, and can be easily recognized as a landmark of the time zone TZ. Thus, the user who uses the electronic watch 1 can correctly select the time zone TZ depending on a purpose of changing the time zone TZ of the user.

In the present embodiment, part of the first displays TD1 and the third displays TD1 are disposed in the inside region E1, and part of the first displays TD1 and the second displays TD2 are disposed in the outside region E2, but the embodiment is not limited thereto. Only the second displays TD2 may be disposed in the outside region E2. The time zone displays TD are disposed on the facing ring 33 as the display unit, but the embodiment is not limited thereto. The time zone displays TD may be disposed on only the dial plate 32, only the bezel 22, only the wind shield 23 covering the time display unit, or two or more of the dial plate 32, the facing ring 33, the bezel 22, and the wind shield 23. In this case, part of the first displays TD1 is preferably disposed on a display unit positioned on a radially inner side, and the second displays TD2 are preferably disposed on a display unit positioned on a radially outer side.

In the present embodiment, each of the first display TD1, the second display TD1, and the third display TD3 corresponds to one of different time zones TZ, but the embodiment is not limited thereto. The first display TD1, the second display TD1, and the third display TD3 may correspond to the same time zone TZ. In a case in which the time zone TZ corresponding to a specific first display TD1X among the first displays TD1 and the time zone TZ corresponding to a specific second display TD2X among the second displays TD2 are the same specific time zone TZX, the specific second display TD2X is displayed on a radially outer side of the specific first display TD1X to be overlapped with the specific first display TD1X in the radial direction. For example, in a case in which “GALAPAGOS” as the second display TD2 representing Galapagos is assumed to be the specific second display TD2X, “CHI” as the first display TD1 representing an abbreviated city name of Chicago, which is a city included in the same specific time zone TZX as that of Galapagos as a landmark, is assumed to be the specific first display TD1X, “CHI” as the first display TD1 is disposed in the inside region E1, “GALAPAGOS” as the second display TD2 is disposed in the outside region E2, and “CHI” and “GALAPAGOS” are disposed to be opposed to each other in the radial direction.

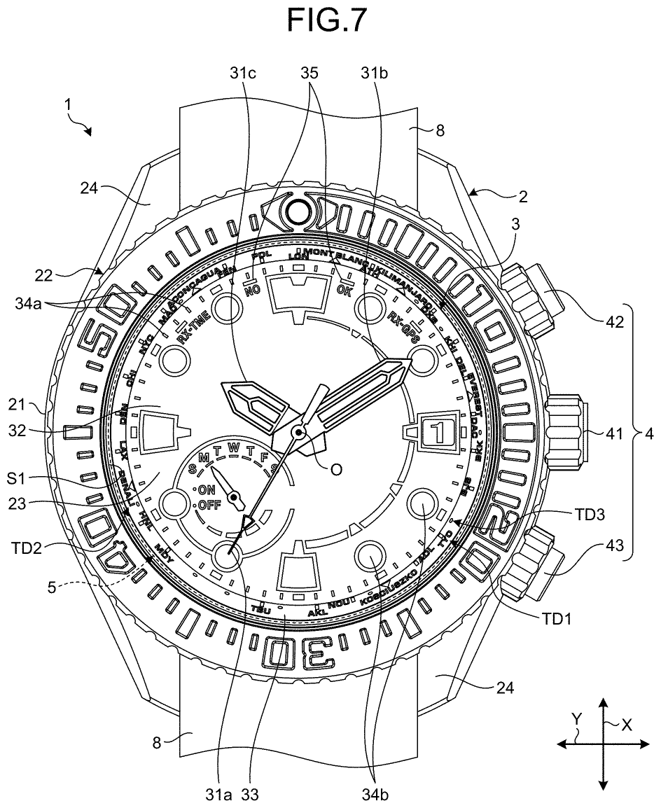

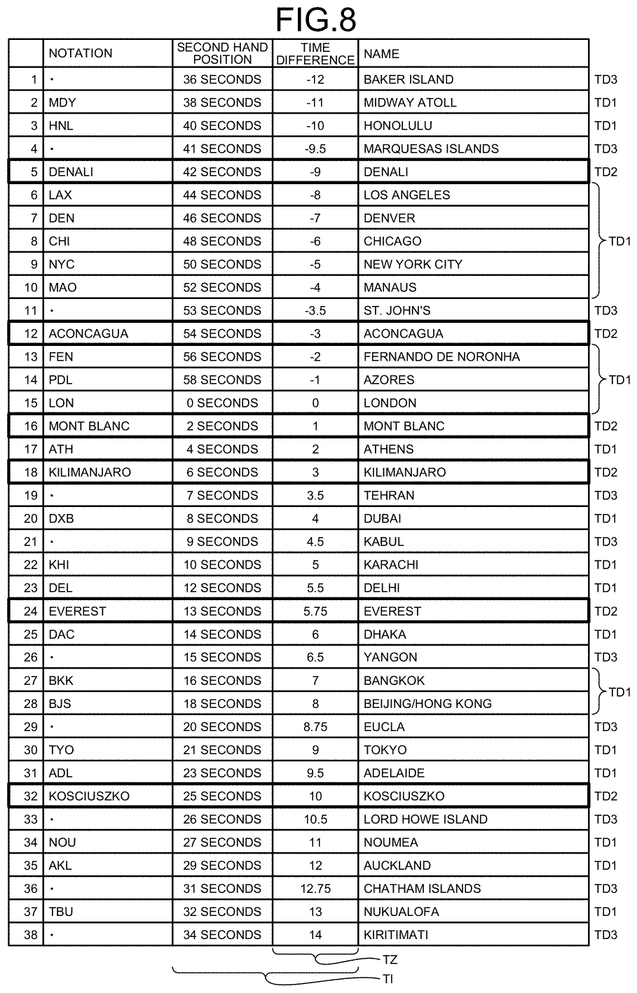

In the present embodiment, the electronic watch 1 has the diving mode, but the electronic watch 1 may also have other modes, for example, a tracking mode, a skydiving mode, and the like in place of the diving mode or in addition to the diving mode based on a specific purpose. FIG. 7 is an entire configuration diagram of the electronic watch according to a modification. FIG. 8 is a diagram related to time zone displays according to the modification. As illustrated in FIG. 7 and FIG. 8, the electronic watch 1 may have the tracking mode. In this case, the second display TD2 is a name of a tracking spot as a landmark included in the corresponding time zone TZ, for example, an unabbreviated name of a mountain such as “DENALI”, “ACONCAGUA”, “MONT BLANC”, “KILIMANJARO”, “EVEREST”, and “KOSCIUSZKO”, and the display mode of the second display TD2 is different from that of the first display TD1. The electronic watch 1 may also have a skydiving mode. In this case, the second display TD2 is an unabbreviated name of an airport included in the corresponding time zone TZ, and the display mode of the second display TD2 is different from that of the first display TD1.

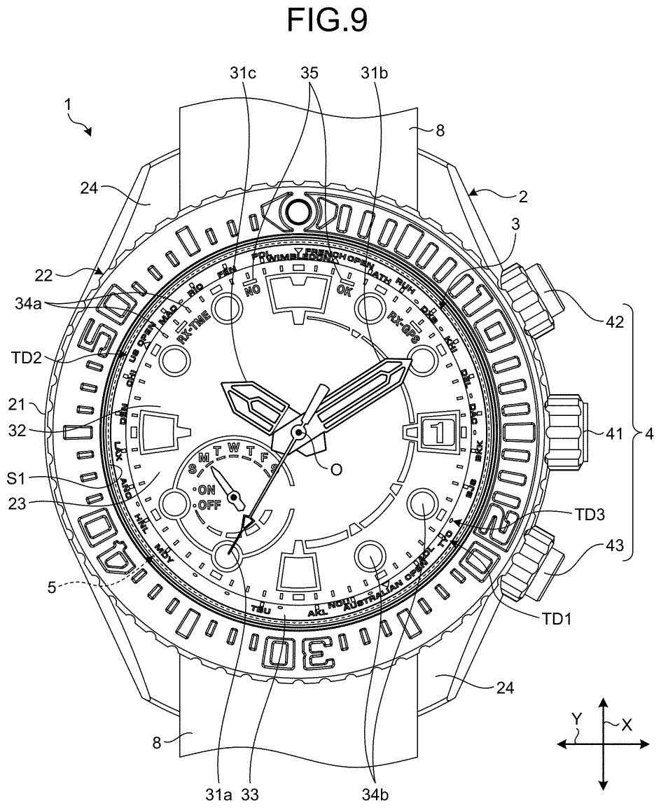

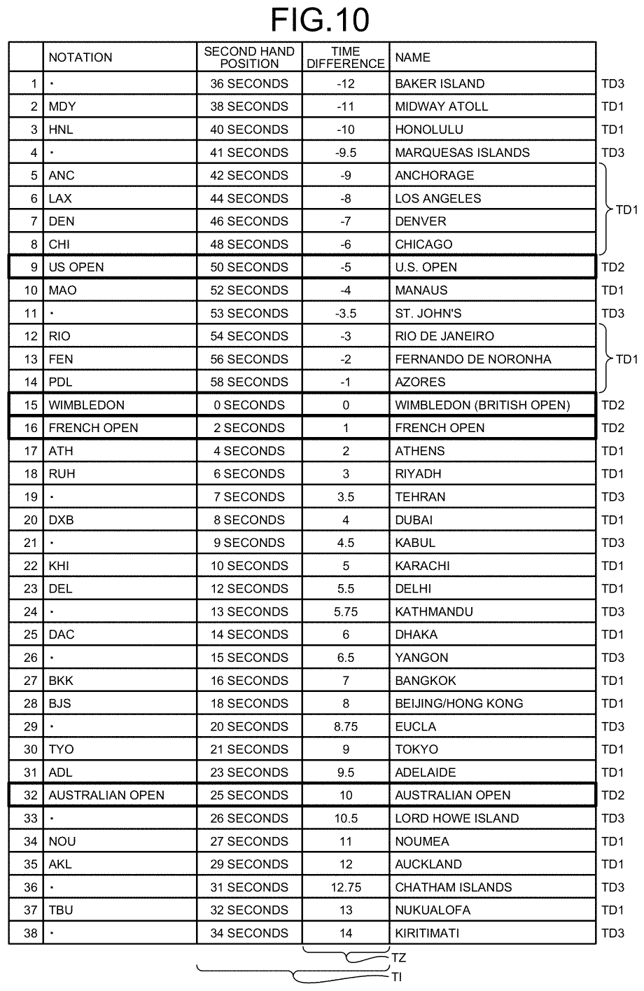

In the present embodiment, the electronic watch 1 has the diving mode, but the electronic watch 1 may be the electronic watch 1 that performs only clocking without including a mode switching unit 62b, that is, without including another mode. FIG. 9 is an entire configuration diagram of the electronic watch according to the modification. FIG. 10 is a diagram related to time zone displays according to the modification. The electronic watch 1 does not include another mode, but the second display TD2 may correspond to tennis as illustrated in FIG. 9 and FIG. 10, for example. In this case, the second display TD2 is a name of a tracking spot as a landmark included in the corresponding time zone TZ, for example, an unabbreviated name of a tennis tournament or a tennis site such as “US OPEN”, “WIMBLEDON”, “FRENCH OPEN”, and “AUSTRALIAN OPEN”, and the display mode of the second display TD2 is different from that of the first display TD1.

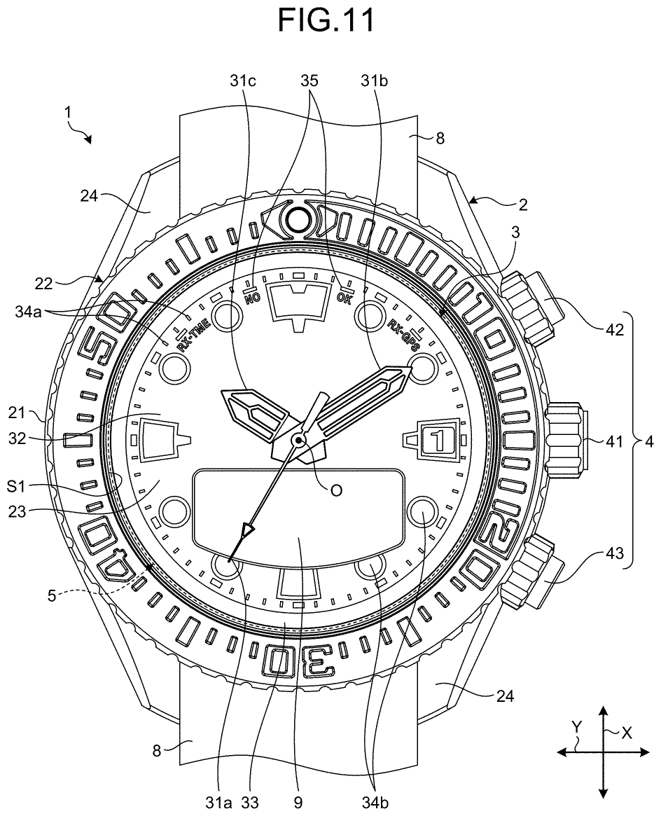

In the present embodiment, the selecting operation is performed as follows: the time zone display TD to be selected from among the time zone displays TD is indicated by the second hand 31a, but the embodiment is not limited thereto. A display monitor (not illustrated) disposed on the time display unit 3 may be used for the selecting operation. FIG. 11 is an entire configuration diagram of the electronic watch according to the modification. A display monitor 9 is disposed so that a display surface is exposed to the dial plate 32 in the movement 5. The display monitor 9 according to the present embodiment is a liquid crystal monitor, and disposed at a position of “6 o'clock” on the dial plate 32. The display monitor 9 may also be an organic EL monitor, electronic paper, or the like, and may be disposed at a position of “12 o'clock”, not limited to the position of “6 o'clock”, on the dial plate 32 while considering to display the first display TD1 and the second display TD2 without abbreviating them. The display monitor 9 is controlled by the control circuit 52, and successively displays the time zone displays TD stored in the storage unit 52c of the control circuit 52 when the user operates the operation unit 4. The time zone displays TD include at least the first display TD1 and the second display TD2. For example, when the user moves the crown 41 from the zeroth step to the first step, the control circuit 52 causes the display monitor to display the time zone display TD corresponding to the time zone TZ corresponding to the time zone information TI stored in the storage unit 52c. Next, when the user checks the current time zone TZ, and rotates the crown 41 or presses the push buttons 42 and 43, the control circuit 52 causes the display monitor to successively display the time zone displays TD. Next, when the time zone display TD corresponding to the time zone TZ to be selected is displayed on the display monitor, the user performs a determination operation of returning the crown 41 from the first step to the zeroth step to determine the time zone. The control circuit 52 then updates the time zone information TI, changes the internal time based on a difference between the time zone information TI before the change and the time zone information after the change, and performs time display based on the changed internal time.

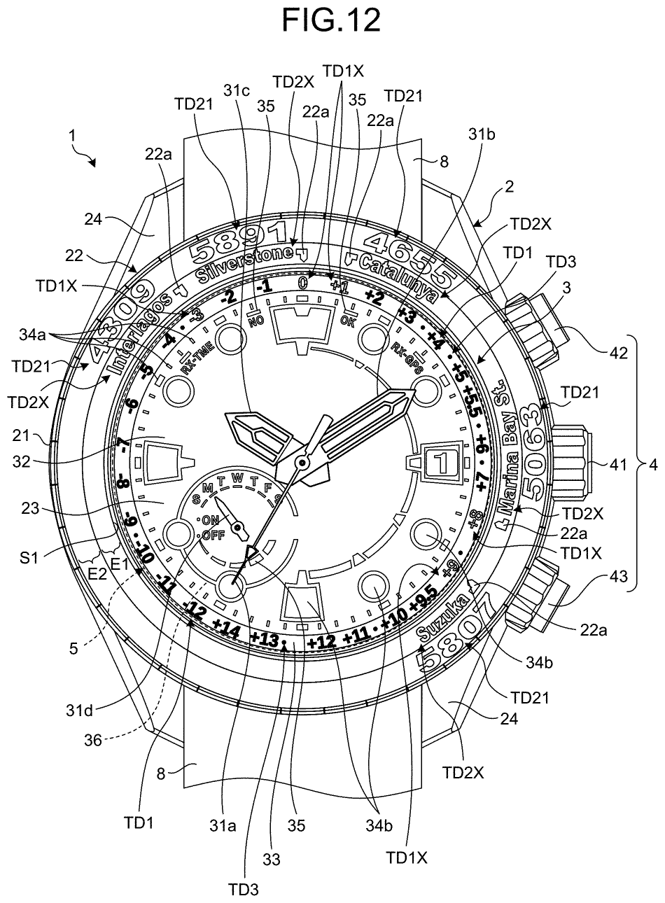

In the present embodiment, the first display TD1, the second display TD2, and the third display TD3 are displayed on the facing ring 33 as the display unit, but the embodiment is not limited thereto. A second display auxiliary display TD21 as specific information related to a landmark corresponding to the second display TD2 may be displayed together with the second display TD2 on the display unit. FIG. 12 is an entire configuration diagram of the electronic watch according to the modification. For example, the electronic watch 1 does not have another mode, and the second display TD2 corresponds to auto racing. In a case in which the time zone TZ corresponding to the specific first display TD1X among the first displays TD1 and the time zone TZ corresponding to the specific second display TD2X are the same specific time zone TZX, the specific second display TD2X is assumed to be displayed on a radially outer side of the specific first display TD1X. As illustrated in FIG. 12, in the electronic watch 1, the first display TD1 (including the specific first display TD1X) is displayed on the facing ring 33 as the display unit, and the specific second display TD2X as the second display TD2 and the second display auxiliary display TD21 are displayed on the bezel 22 as the display unit. In this case, the first display TD1 is a display based on a time difference. On the facing ring 33, based on “0” as the specific first display TD1X corresponding to a reference area (0) in the time zone TZ, “+1” as the specific first display TD1X and “+2” as the first display TD1 are displayed in order of time difference in one direction along the circumferential direction, and “−1” as the first display TD1 and “−2” as the first display TD1 are displayed in order of time difference in the other direction along the circumferential direction. The specific second display TD2X as the second display TD2 is a name of a circuit as a landmark included in the corresponding time zone TZ, for example, “Interlagos” corresponding to “−3” as the specific first display TD1X, “Silverstone” corresponding to “0” as the specific first display TD1X, “Catalunya” corresponding to “+1” as the specific first display TD1X, “Marina Bay St.” corresponding to “+8” as the specific first display TD1X, and “Suzuka” corresponding to “+9” as the specific first display TD1X, which are not abbreviated. The display mode of the specific second display TD2X is different from that of the corresponding specific first display TD1X, and the specific second display TD2X is displayed in the inside region E1 of the bezel 22. The second display auxiliary display TD21 is a total length of a course of each circuit represented by the metric system as specific information related to a landmark corresponding to the second display TD2. The second display auxiliary display TD21 is “4309” corresponding to “Interlagos” as the specific second display TD2X, “5891” corresponding to “Silverstone” as the specific second display TD2X, “4655” corresponding to “Catalunya” as the specific second display TD2X, “5063” corresponding to “Marina Bay St.” as the specific second display TD2X, “5807” corresponding to “Suzuka” as the specific second display TD2X, or the like, and is displayed to be overlapped with the corresponding specific second display TD2X in the radial direction in the outside region E2 of the bezel 22. The display mode of the specific first display TD1X is different from that of the first display TD1. Auxiliary symbols 22a corresponding to the respective specific second displays TD2X are disposed on the bezel 22. Each of the auxiliary symbols 22a is a symbol for associating the specific first display TD1X with the specific second display TD2X. The auxiliary symbol 22a is disposed in the inside region E1 of the bezel 22, corresponds to the specific second display TD2X disposed in the same region E1, positioned on one of both end parts in the circumferential direction of the specific second display TD2X, and positioned to be opposed to the specific first display TD1X in the radial direction. As described above, the second display auxiliary display TD21 as specific information related to a landmark corresponding to the second display TD2 is displayed together with the second display TD2 on the display unit, so that the user can identify the second display TD2 as the time zone display TD corresponding to a specific purpose more easily due to the second display auxiliary display TD21, and can easily recognize the second display TD2 as the landmark of the time zone TZ.

Regarding the electronic watch 1 described above, described is a case in which the second display TD2 corresponds to auto racing. Alternatively, in a case in which the second display TD2 corresponds to a mountain, the second display TD2 may be a “name of a mountain”, and the second display auxiliary display TD21 may be a “height above the sea level”, for example. In a case in which the second display TD2 corresponds to tennis, the second displays TD2 may be “names of four major tournaments”, and the second display auxiliary displays TD21 may be “month of the tournament”, “surface of the court (such as Glass, Hard, or Clay)”, and the like. In a case in which the second display TD2 corresponds to a theme park, the second display TD2 may be a “name of the theme park”, and the second display auxiliary displays TD21 may be “the number of attractions”, “anniversary of park opening”, and the like. In a case in which the second display TD2 corresponds to a World Heritage site, the second display TD2 may be a “name of the World Heritage site”, and the second display auxiliary display TD21 may be a “registration year” and the like. Regarding the electronic watch 1 described above, the number of the second display auxiliary displays TD21 as specific information related to a landmark corresponding to the second display TD2 is one, but the embodiment is not limited thereto. The number of the second display auxiliary displays TD21 may be two or more. In this case, a second display auxiliary display as specific information having an attribute different from that of the specific information corresponding to the second display auxiliary display TD21 is preferably displayed on the display unit. For example, in a case in which the second display TD2 of the electronic watch 1 corresponds to tennis, and the second display auxiliary display TD21 corresponding to each of the second displays TD2 is a month of a tournament, another second display auxiliary display TD22 representing a surface of the court (such as Glass, Hard, or Clay) may be displayed in the outside region E2 together with the second display auxiliary display TD21. In the electronic watch 1 described above, the second display auxiliary display TD2 is disposed on the radially outer side than the first display TD1 and the second display TD2, but the embodiment is not limited thereto. The second display auxiliary display TD2 may be disposed on the radially inner side than at least one of the first display TD1 and the second display TD2. For example, the first display TD1 and the second display TD2 may be displayed on the facing ring 33, and the second display auxiliary display TD21 may be displayed on the dial plate 31.

In the present embodiment, one type of landmark corresponds to the second display TD2, but the embodiment is not limited thereto. Two or more types of landmarks may correspond to the second display TD2. For example, the second displays TD2 may be a “name of a diving spot” and a “name of a World Heritage site”. On the electronic watch 1, the same type of display as the landmark corresponding to the second display TD2 not corresponding to a time difference may be displayed together with the second display TD2.

### REFERENCE SIGNS LIST

1 ELECTRONIC WATCH

2 EXTERIOR CASE

21 CASE BODY

22 BEZEL

23 WIND SHIELD

24 BOW

3 TIME DISPLAY UNIT

31 HAND

32 DIAL PLATE

33 FACING RING (DISPLAY UNIT)

33a to 33c AUXILIARY SYMBOL

34 TIME CHARACTER

35 FUNCTIONAL MARK

36 SUB-DISPLAY UNIT

4 OPERATION UNIT

41 CROWN

42, 43 PUSH BUTTON

5 MOVEMENT

51 OSCILLATOR

52 CONTROL CIRCUIT

52a TIME SETTING UNIT

52b MODE SWITCHING UNIT

52c STORAGE UNIT

53 DRIVING MECHANISM

54 POWER GENERATION MECHANISM

55 SECONDARY CELL

8 BELT

9 DISPLAY MONITOR

TZ TIME ZONE

TD TIME ZONE DISPLAY

TD1 FIRST DISPLAY

TD2 SECOND DISPLAY

TD3 THIRD DISPLAY

TI TIME ZONE INFORMATION

1-12. (canceled)

13. An electronic watch comprising:
a time display unit configured to perform time display based on an internal time;
a control circuit including a time setting unit configured to set the internal time based on a reference time and a time zone;
a display unit configured to perform time zone display corresponding to each of a plurality of time zones; and
an operation unit configured to perform selecting operation of selecting one time zone from among the time zones on the display unit, wherein
the time zone display includes:
one or more first displays based on a city name included in a time zone, a region, or a time difference, and
one or more second displays based on a landmark included in the time zone.

14. The electronic watch according to claim 13, wherein
the time display unit includes a hand configured to be rotated by an operation of the operation unit, and
the hand indicates the time zone display displayed on the display unit in accordance with the selecting operation of the operation unit.

15. The electronic watch according to claim 13, wherein
at least one of color, a font, and a size of each of the second displays is different from color, a font, or a size of each of the first display.

16. The electronic watch according to claim 14, wherein
at least one of color, a font, and a size of each of the second displays is different from color, a font, or a size of each of the first display.

17. The electronic watch according to claim 13, wherein
the display unit is at least one of a dial plate and a facing ring of the time display unit, a bezel positioned on an outer circumference of the time display unit, and a wind shield covering the time display unit, and
the first displays and the second displays are displayed on the display unit in order of time difference.

18. The electronic watch according to claim 14, wherein
the display unit is at least one of a dial plate and a facing ring of the time display unit, a bezel positioned on an outer circumference of the time display unit, and a wind shield covering the time display unit, and
the first displays and the second displays are displayed on the display unit in order of time difference.

19. The electronic watch according to claim 15, wherein
the display unit is at least one of a dial plate and a facing ring of the time display unit, a bezel positioned on an outer circumference of the time display unit, and a wind shield covering the time display unit, and
the first displays and the second displays are displayed on the display unit in order of time difference.

20. The electronic watch according to claim 17, wherein
each of the second displays is positioned on a radially outer side than at least part of the first displays with respect to a rotation axis of the hand.

21. The electronic watch according to claim 13, wherein
each of the first displays and each of the second displays respectively correspond to the different time zones.

22. The electronic watch according to claim 13, wherein
the time zone corresponding to a specific first display among the first displays and the time zone corresponding to a specific second display among the second displays are same specific time zone, and
the specific second display is displayed on a radially outer side of the specific first display to be overlapped with the specific first display in a radial direction.

23. The electronic watch according to claim 13, wherein
the operation unit is used for switching between a clocking mode and a diving mode, and
the second display includes a name of a diving spot.

24. The electronic watch according to claim 13, wherein
the operation unit is used for switching between a clocking mode and a tracking mode, and
the second display includes a name of a tracking spot.

25. The electronic watch according to claim 13, wherein
the operation unit is used for switching between a clocking mode and a skydiving mode, and
the second display includes a name of an airport.

26. The electronic watch according to claim 13, wherein
the time display unit
includes a display monitor configured to successively display the time zones, and
causes the display monitor to successively display the time zone display in accordance with the selecting operation by the operation unit, and performs a determination operation of determining the time zone in accordance with an operation by the operation unit.

27. The electronic watch according to claim 13, wherein
the display unit performs a second display auxiliary display as specific information related to the landmark corresponding to the second display together with the second display.
